(19) United States
(12) Patent Application Publication
(10) Pub. No.: US 2025/0251642 A1
(43) Pub. Date: Aug. 7, 2025

(54) UNIVERSAL PHOTONIC CIRCUITS WITH CASCADABLE PHOTONIC GATES BASED ON NONLINEARITIES

(71) Applicant: Milkshake Technology Inc., Menlo Park, CA (US)

(72) Inventors: Bicky A. Marquez, Kingston (CA); Bhavin J. Shastri, Kingston (CA); Alireza Samani, Ottawa (CA); Douglas H. Wightman, Kingston (CA)

(21) Appl. No.: 18/435,300

(22) Filed: Feb. 7, 2024

(51) Int. Cl. G02F 3/00

(52) U.S. Cl. CPC G02F 3/00

(57) ABSTRACT

A photonic circuit configured to operate as a universal photonic gate. The photonic circuit includes at least a first photonic gate and a first nonlinear photonic circuit coupled to the first photonic gate. The first photonic gate receives one or more photonic input signals and generates, based at least in part on the one or more photonic input signals, one or more first photonic intermediate output signals. The first nonlinear photonic circuit receives the one or more first photonic intermediate output signals and generates one or more first photonic output signals by applying a first nonlinear transfer function of the first nonlinear photonic circuit to the one or more first photonic intermediate output signals. A logical function of the photonic circuit depends on phase shifts applied by phase shifters of the first photonic gate and an amplitude value of a bias signal input into the first photonic gate.

### TECHNICAL FIELD

The present disclosure generally relates to a processor architecture and, more specifically, to universal photonic circuits with cascadable photonic gates based on nonlinearities.

### BACKGROUND

Photonic hardware is favorable for applications requiring high bandwidth, low latency, and low switching energy for signal processing, data communications, and information processing (i.e., computing systems and operations). Recent innovations in silicon photonic fabrication have enabled the on-chip implementation of photonic circuits. This has opened a low-cost, high-precision, and scalable avenue for the development of photonic computing. Advances in photonic computing have demonstrated suitability for applications requiring high-bandwidth parallel processing, especially neural networks, offering higher speed and less energy consumption than equivalent networks implemented in digital and/or analog electronics.

However, different phases of optical signals (i.e., light signals) processed by a photonic gate can cause amplitude errors and/or phase errors at an output of the photonic gate. Furthermore, circuitry for photonic computing typically employs cascaded photonic gates, and the amplitude errors and/or phase errors can propagate and accumulate through photonic circuitry that includes cascaded photonic gates. Also, optical signals propagating through one or more photonic gates can suffer from degradations in signal quality. Additionally, an input of one photonic gate may need to be able to be driven by outputs of multiple photonic gates, and an output of the photonic gate may need to be sufficient to drive multiple subsequent photonic gates. Therefore, the practical photonic logic needs to fulfil requirements for cascadability, logic-level restoration, fan-in, and fan-out.

### SUMMARY

Embodiments of the present disclosure are directed to a photonic circuit operating as a universal photonic gate that fulfils requirements for cascadability, logic-level restoration, fan-in, and fan-out. The photonic circuit may include at least a first photonic gate having a first set of one or more inputs and a first set of one or more outputs, and a first nonlinear photonic circuit having one or more first inputs and one or more first outputs. The first set of one or more inputs is configured to receive one or more photonic input signals, and the first photonic gate is configured to generate, based at least in part on the one or more photonic input signals, one or more first photonic intermediate output signals at the first set of one or more outputs. The one or more first inputs of the first the nonlinear photonic circuit are coupled to the first set of one or more outputs and configured to receive the one or more first photonic intermediate output signals. The first nonlinear photonic circuit is configured to generate one or more first photonic output signals at the one or more first outputs by applying a first nonlinear transfer function of the first nonlinear photonic circuit to the one or more first photonic intermediate output signals.

Embodiments of the present disclosure are further directed to a non-transitory computer-readable storage medium comprising stored instructions. The instructions, when executed by at least one processor, cause the at least one processor to execute operations. The operations are comprised to: instruct a first photonic gate of a photonic circuit to receive one or more photonic input signals at a first set of one or more inputs; instruct the first photonic gate to generate, based at least in part on the one or more photonic input signals, one or more first photonic intermediate output signals at a first set of one or more outputs; instruct a first nonlinear photonic circuit of the photonic circuit to receive the one or more first photonic intermediate output signals at one or more first inputs; and instruct the nonlinear photonic circuit to generate one or more first photonic output signals at one or more first outputs by applying a first nonlinear transfer function of the first nonlinear photonic circuit to the one or more first photonic intermediate output signals. The non-transitory computer-readable storage medium can be a digital storage medium, an analog storage medium, an optical storage medium, some other type of storage medium, or some combination thereof. The at least one processor can be an optical processor, an electronic processor (e.g., central processing unit (CPU) processor, machine learning (ML) processor, graphics processing unit (GPU) processor), some other type of processor, or some combination thereof.

Embodiments of the present disclosure are further directed to a method for operating a photonic circuit functioning as a universal photonic gate that supports requirements for cascadability, fan-in, fan-out, and logic-level restoration. The method comprises: receiving one or more photonic input signals at a first set of one or more inputs of a first photonic gate of a photonic circuit; generating, by the first photonic gate at a first set of one or more outputs, one or more first photonic intermediate output signals based at least in part on the one or more photonic input signals; receiving the one or more first photonic intermediate output signals at one or more first inputs of a first nonlinear photonic circuit of the photonic circuit; and generating, by the first nonlinear photonic circuit at one or more first outputs, one or more first photonic output signals by applying a first nonlinear transfer function of the first nonlinear photonic circuit to the one or more first photonic intermediate output signals.

### BRIEF DESCRIPTION OF THE DRAWINGS

FIG. 1 illustrates an example photonic circuit that includes a cascading connection of a pair of photonic gates and a pair of nonlinear photonic circuits, in accordance with some embodiments.

FIG. 2 illustrates a first example photonic circuit with a cascading connection of photonic gates and nonlinear photonic circuits, in accordance with some embodiments.

FIG. 3A illustrates an example graph of a transfer function of one or more nonlinear photonic circuits that is represented as a three-region piece-wise function, in accordance with some embodiments.

FIG. 3B illustrates another example graph of a transfer function of one or more nonlinear photonic circuits that is represented as a three-region piece-wise function, in accordance with some embodiments.

FIG. 4A illustrates examples of different configurations of a nonlinear photonic circuit, in accordance with some embodiments.

FIG. 4B illustrates an example graph of a transfer function of a configuration of the nonlinear photonic circuit in FIG. 4A, in accordance with some embodiments.

FIG. 5 is a flowchart illustrating an example method for operating a photonic circuit as a universal photonic gate, in accordance with some embodiments.

The figures depict embodiments of the present disclosure for purposes of illustration only. One skilled in the art will readily recognize from the following description that alternative embodiments of the structures and methods illustrated herein can be employed without departing from the principles or benefits touted by the disclosure described herein.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that can be employed without departing from the principles of what is claimed.

Reference will now be made in detail to several embodiments, examples of which are illustrated in the accompanying figures. It is noted that wherever practicable, similar or like reference numbers can be used in the figures and can indicate similar or like functionality. The figures depict embodiments of the disclosed system (or method) for illustration only. One skilled in the art will readily recognize from the following description that alternative embodiments of the structures and methods illustrated herein can be employed without departing from the principles described herein.

Embodiments of the present disclosure are directed to photonic circuits operating as universal photonic gates that fulfill requirements for cascadability, logic-level restoration, fan-in, and fan-out. The photonic circuits presented herein can perform multiple logic operations on photonic signals by employing cascading connections of linear photonic gates and one or more nonlinear photonic components.

Photonic Circuits with Nonlinear Component

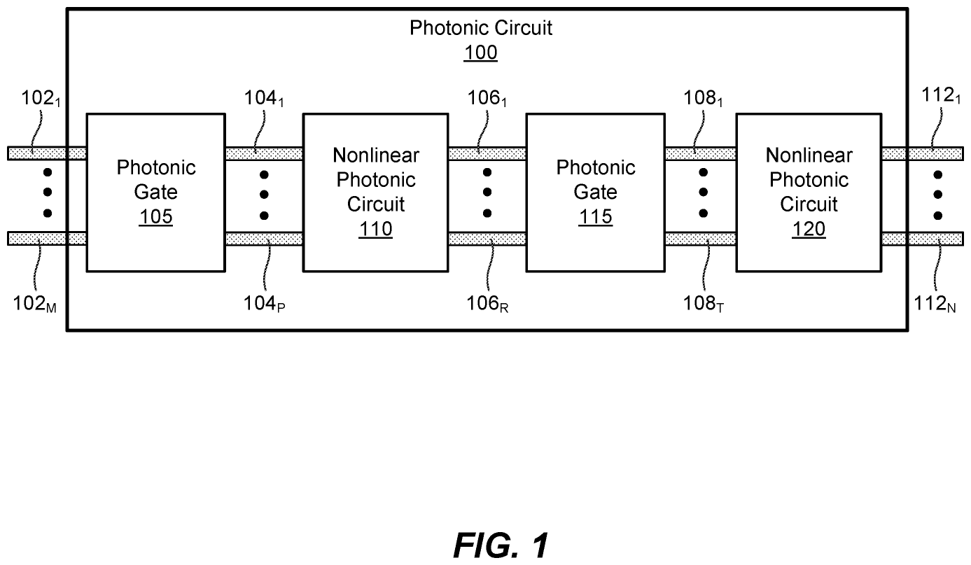

Figure (FIG. 1 illustrates an example photonic circuit 100, in accordance with some embodiments. The photonic circuit 100 may receive one or more photonic input signal 102₁, . . . , 102_{M} (e.g., M≥1) at a set of one or more input ports of the photonic circuit 100 and generate one or more photonic output signals 112₁, . . . , 112_{N} (e.g., N≥1) at a set of one or more output ports of the photonic circuit 100. The one or more photonic input signals 102₁, . . . , 102_{M} may be generated by one or more lasers coupled to the set of one or more input ports of the photonic circuit 100. Alternatively, the one or more photonic input signals 102₁, . . . , 102_{M} may be generated by one or more photonic circuits having one or more output ports coupled to the set of one or more input ports of the photonic circuit 100. Each of one or more photonic input signals 102₁, . . . , 102_{M} may be a light signal of corresponding input amplitudes (that each corresponds to logical “1” or logical “0”), corresponding input phases and/or corresponding input modes (i.e., input light spatial distribution and/or input wavelengths) injected into each of the one or more input ports of the photonic circuit 100. In one or more embodiments, at least one of the one or more photonic input signals 102₁, . . . , 102_{M} is a bias signal having a constant amplitude over time.

The photonic circuit 100 may include a cascading connection of a pair of first and second photonic gates 105, 115 and a pair of first and second nonlinear photonic circuits 110, 120. A set of one or more input ports of the first photonic gate 105 may be coupled to the set of one or more input ports of the photonic circuit 100, and a set of one or output ports of the first photonic gate 105 may be coupled to a set of one or more input ports of the first nonlinear photonic circuit 110. A set of one or more output ports of the first nonlinear photonic circuit 110 may be coupled to a set of one or more input ports of the second photonic gate 115, and a set of one or more output ports of the second photonic gate 115 may be coupled to a set of one or more input ports of the second nonlinear photonic circuit 120. And a set of one or more output ports of the second nonlinear photonic circuit 120 may be coupled to the set of one or more output ports of the photonic circuit 100. The photonic circuit 100 may include fewer or additional components not shown in FIG. 1, such as, but not limited to, phase shifters for compensation of fabrication variations, linear photonic amplifiers, photonic attenuators, photonic phase thresholders, and/or photonic amplitude thresholders.

The first photonic gate 105 may receive, at one or more input ports, the one or more photonic input signals 102₁, . . . , 102_{M}. The set of one or more input ports of the first photonic gate 105 may represent, e.g., a set of waveguides, a set of waveguide polarizations, a set of waveguide modes, a set of light wavelengths, etc. The set of one or more input ports of the first photonic gate 105 may also represent the one or more input ports of the photonic circuit 100. The first photonic gate 105 may generate one or more photonic signals 104₁, . . . 104_{P} (e.g., P≥1) based on the one or more photonic input signals 102₁, . . . , 102_{M}. The first photonic gate 105 may include one or more linear photonic elements. The one or more photonic signals 104₁, . . . 104_{P} generated by the first photonic gate 105 may be output at one or more output ports of the first photonic gate 105. The set of one or more output ports of the first photonic gate 105 may represent, e.g., a set of waveguides, a set of waveguide polarizations, a set of waveguide modes, a set of light wavelengths, one or more signals radiated by the first photonic gate 105, etc. The first photonic gate 105 may pass the one or more photonic signals 104₁, . . . 104_{P} to the first nonlinear photonic circuit 110.

The first nonlinear photonic circuit 110 may receive, at one or more input ports, the one or more photonic signals 104₁, . . . 104_{P}. The set of one or more input ports of the first nonlinear photonic circuit 110 may represent, e.g., a set of waveguides, a set of waveguide polarizations, a set of waveguide modes, a set of light wavelengths, etc. The first nonlinear photonic circuit 110 may generate one or more photonic signals 106₁, . . . , 106_{R} (e.g., R≥1) by applying a nonlinear transfer function to the one or more photonic signals 104₁, . . . , 104_{P}. Given that the first photonic gate 105 may include only one or more linear photonic elements, the one or more photonic signals 104₁, . . . 104_{P} generated by the first photonic gate 105 may have one or more accumulative errors (e.g., one or more phase errors, one or more amplitude errors, one or more mode errors, one or more wavelength errors, one or more bit-errors, some other type of error, or some combination thereof). The first nonlinear photonic circuit 110 coupled to the set of one or more output ports of the first photonic gate 105 may correct the one or more accumulative errors in the one or more photonic signals 104₁, . . . 104_{P}, i.e., the one or more photonic signals 106₁, . . . , 106_{R} generated by the nonlinear photonic circuit 110 may be error-free photonic signals with restored logic levels.

An operating regime of the first nonlinear photonic circuit 110 may depend on a level of each amplitude of the one or more photonic signals 104₁, . . . , 104_{P}. The first nonlinear photonic circuit 110 may saturate one or more amplitudes of the one or more photonic signals 104₁, . . . , 104_{P} when operating in one or more operating regimes that are typically referred to as “nonlinear” operating regime(s). Otherwise, the first nonlinear photonic circuit 110 may operate in an operating regime typically referred to as a “linear” optical regime when the first nonlinear photonic circuit 110 applies a transfer gain of a “linear region” of the nonlinear transfer function to one or more one or more amplitudes of the one or more photonic signals 104₁, . . . , 104_{P} when generating one or more amplitudes of the one or more photonic signals 106₁, . . . , 106_{R}.

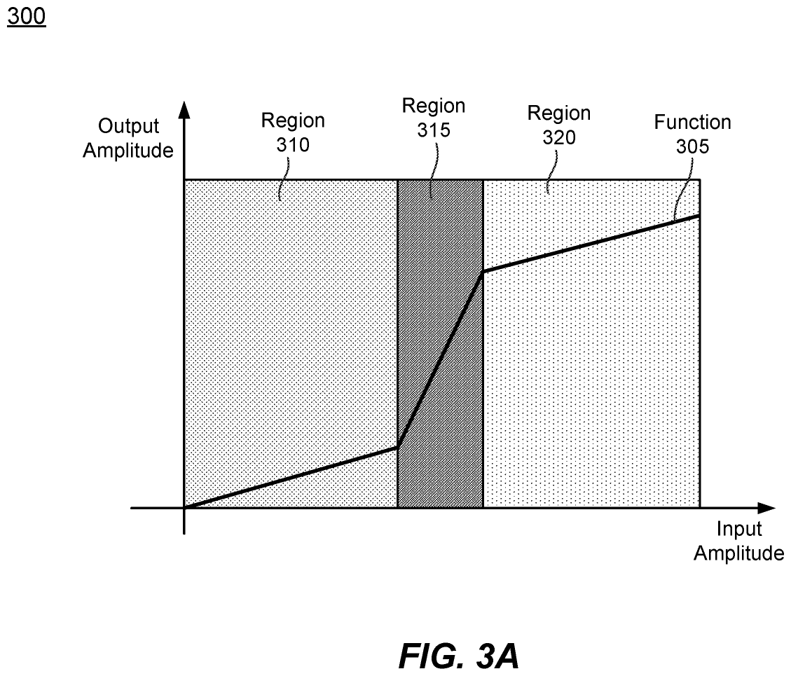

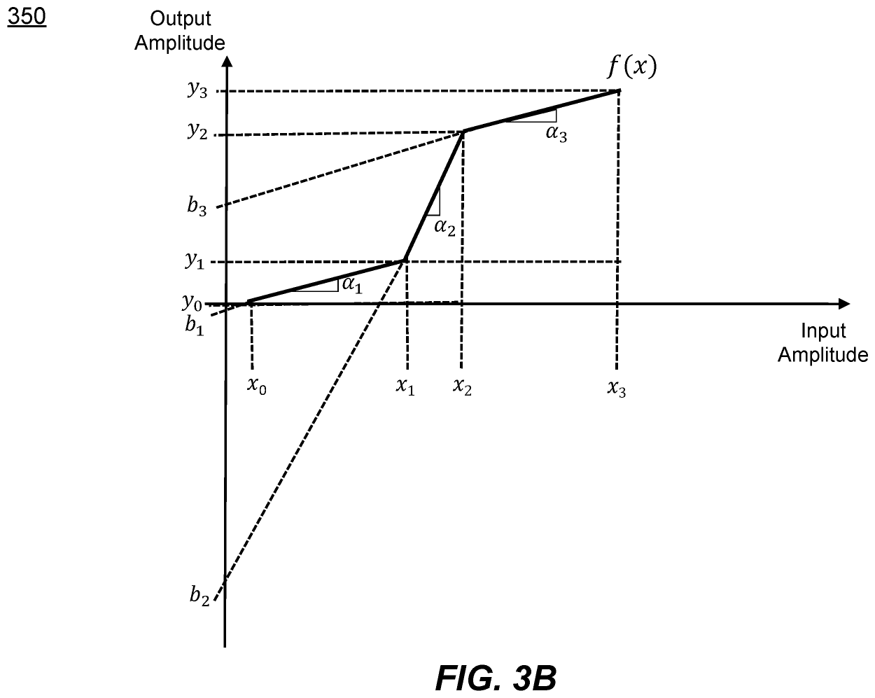

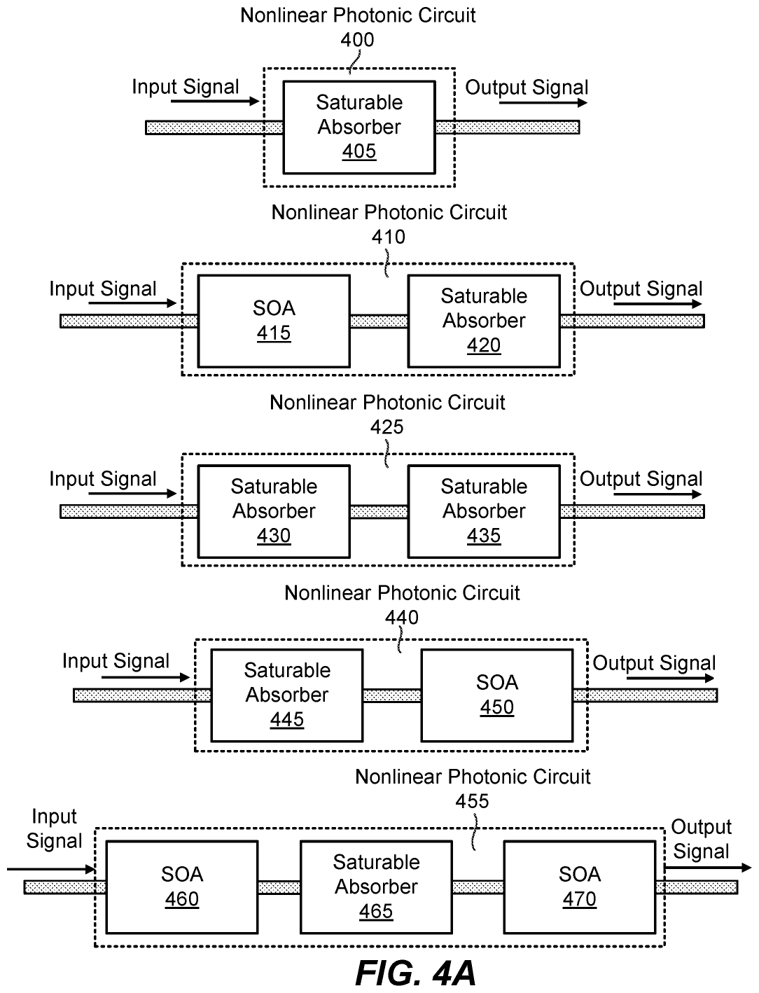

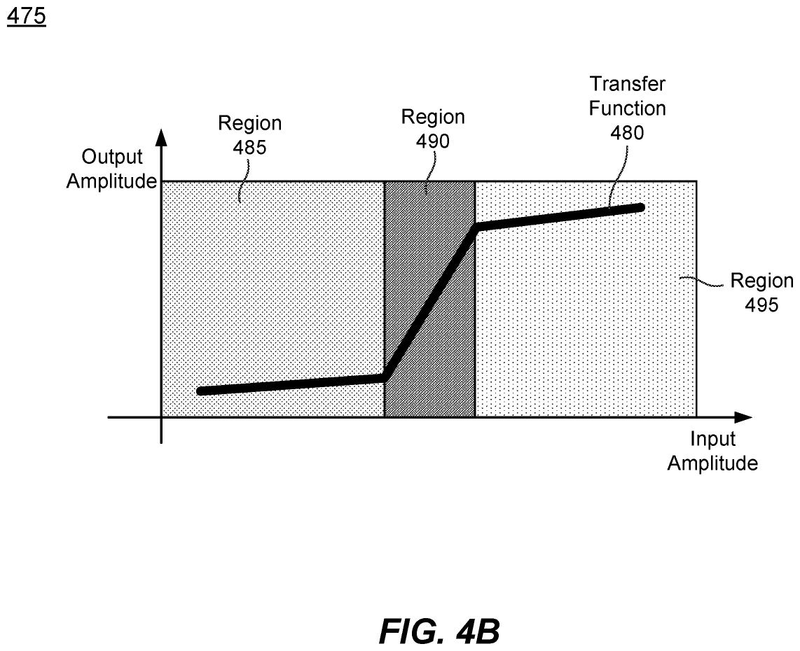

The first nonlinear photonic circuit 110 may be implemented as one or more all-optical amplitude thresholders. An all-optical amplitude thresholder can be implemented with a variety of approaches in integrated or free-space, and variants or combinations thereof, including but not limited to a resonator-based device or circuit, a saturable absorber including based on graphene, MoS2 or other 2D materials, carbon nanotube, dye, unpumped gain medium, saturable semiconductor cavity laser mirror (i.e., SESAM), or a semiconductor absorber (e.g., quantum dots semiconductor optical amplifier (SOA), ion-implanted, reverse-biased or unpumped semiconductor, etc.), or artificial saturable absorber (e.g., Kerr lensing, nonlinear polarization rotation, fiber loop mirror, etc.). The first nonlinear photonic circuit 110 implemented as the one or more all-optical amplitude thresholders may block light signals having intensity levels below a threshold value and propagate light signals having intensity levels above the threshold value. More details about transfer functions, operations, and different configurations of the first nonlinear photonic circuit 110 are described in relation to FIGS. 3A through 4B.

The one or more photonic signals 106₁, . . . 106_{R} generated by the first nonlinear photonic circuit 110 may be output at one or more output ports of the first nonlinear photonic circuit 110. The set of one or more output ports of the first nonlinear photonic circuit 110 may represent, e.g., a set of waveguides, a set of waveguide polarizations, a set of waveguide modes, a set of light wavelengths, one or more signals radiated by the first nonlinear photonic circuit 110, etc. In one or more embodiments, the one or more photonic signals 106₁, . . . 106_{R} generated by the cascading connection of the first photonic gate 105 and the first nonlinear photonic circuit 110 represent a result of a logic function of the one or more photonic input signals 102₁, . . . , 102_{M}. The first nonlinear photonic circuit 110 may pass the one or more photonic signals 106₁, . . . 106_{R} to the second photonic gate 115. Additionally, the first nonlinear photonic circuit 110 may pass the one or more photonic signals 106₁, . . . , 106_{R} to one or more other photonic gates (not shown in FIG. 1). Hence, the set of one or more output ports of the first nonlinear photonic circuit 110 may also represent an additional set of one or more output ports of the photonic circuit 100.

The second photonic gate 115 may receive, at one or more input ports, the one or more photonic signals 106₁, . . . , 106_{R}. The set of one or more input ports of the photonic gate 115 may represent, e.g., a set of waveguides, a set of waveguide polarizations, a set of waveguide modes, a set of light wavelengths, etc. The second photonic gate 115 may generate one or more photonic signals 108₁, . . . 108_{T} (e.g., T≥1) based on the one or more photonic signals 106₁, . . . , 106_{R}. The second photonic gate 115 may include one or more linear photonic elements. The one or more photonic signals 108₁, . . . 108_{T} generated by the second photonic gate 115 may be output at one or more output ports of the second photonic gate 115. The set of one or more output ports of the second photonic gate 115 may represent, e.g., a set of waveguides, a set of waveguide polarizations, a set of waveguide modes, a set of light wavelengths, one or more signals radiated by the second photonic gate 115, etc. The second photonic gate 115 may pass the one or more photonic signals 108₁, . . . 108_{T} to the second nonlinear photonic circuit 120.

The second nonlinear photonic circuit 120 may receive, at one or more input ports, the one or more photonic signals 108₁, . . . 108_{T}. The set of one or more input ports of the second nonlinear photonic circuit 120 may represent, e.g., a set of waveguides, a set of waveguide polarizations, a set of waveguide modes, a set of light wavelengths, etc. The second nonlinear photonic circuit 120 may generate the one or more photonic output signals 112₁, . . . , 112_{N} by applying a nonlinear transfer function to the one or more photonic signals 108₁, . . . , 108_{T}. Given that the second photonic gate 115 may include only one or more linear photonic elements, the one or more photonic signals 108₁, . . . 108_{T} generated by the second photonic gate 115 may have one or more accumulative errors (e.g., one or more phase errors, one or more amplitude errors, one or more mode errors, one or more wavelength errors, one or more bit-errors, some other type of error, or some combination thereof). The second nonlinear photonic circuit 120 coupled to the set of one or more output ports of the second photonic gate 115 may correct the one or more accumulative errors in the one or more photonic signals 108₁, . . . 108_{T}, i.e., the one or more photonic output signals 112₁, . . . , 112_{N} generated by the nonlinear photonic circuit 120 may be error-free photonic signals with restored logic levels.

An operating regime of the second nonlinear photonic circuit 120 may depend on a level of each amplitude of the one or more photonic signals 108₁, . . . , 108_{T}. The second nonlinear photonic circuit 120 may saturate one or more amplitudes of the one or more photonic signals 108₁, . . . , 108_{T} when operating in one or more operating regimes that are typically referred to as “nonlinear” operating regime(s). Otherwise, the second nonlinear photonic circuit 120 may operate in an operating regime typically referred to as a “linear” optical regime when the second nonlinear photonic circuit 120 applies a transfer gain of a “linear region” of the nonlinear transfer function to one or more one or more amplitudes of the one or more photonic signals 108₁, . . . , 108_{T} when generating one or more amplitudes of the one or more photonic output signals 112₁, . . . , 112_{N}.

The second nonlinear photonic circuit 120 may be implemented as one or more all-optical amplitude thresholders. An all-optical amplitude thresholder can be implemented with a variety of approaches in integrated or free-space, and variants or combinations thereof, including but not limited to a resonator-based device or circuit, a saturable absorber including based on graphene, MoS2 or other 2D materials, carbon nanotube, dye, unpumped gain medium, saturable semiconductor cavity laser mirror (i.e., SESAM), or a semiconductor absorber (e.g., quantum dots SOA, ion-implanted, reverse-biased or unpumped semiconductor, etc.), or artificial saturable absorber (e.g., Kerr lensing, nonlinear polarization rotation, fiber loop mirror, etc.). The second nonlinear photonic circuit 120 implemented as the one or more all-optical amplitude thresholders may block light signals having intensity levels below a threshold value and propagate light signals having intensity levels above the threshold value. More details about transfer functions, operations, and different configurations of the second nonlinear photonic circuit 120 are described in relation to FIGS. 3A through 4B.

The one or more photonic output signals 112₁, . . . 112_{N} generated by the cascading connection of the first photonic gate 105, the first nonlinear photonic circuit 110, the second photonic gate 115, and the second nonlinear photonic circuit 120 may represent a result of a logic function of the one or more photonic input signals 102₁, . . . , 102_{M}. It should be noted that the one or more photonic output signals 112₁, . . . 112_{N} may be error-free photonic signals with restored logic levels due to operations of the first and second nonlinear photonic circuits 110, 120. The second non-linear photonic circuit 120 may pass the one or more photonic output signals 112₁, . . . 112_{N} to one or more other photonic gates (not shown in FIG. 1). And the set of one or more output ports of the non-linear photonic circuit 120 may represent the set of one or more output ports of the photonic circuit 100. Hence, the output ports of the photonic circuit 100 (e.g., the set of one or more output ports of the first nonlinear photonic circuit 110 and the set of one or more output ports of the second non-linear photonic circuit 120) may be coupled to a plurality of photonic circuits. Also, the set of one or more input ports of the photonic circuit 100 (e.g., the set of one or more input ports of the first photonic gate 105) may be driven by one or more output ports of multiple cascading stages of photonic gates. Therefore, the photonic circuit 100 may operate as a universal photonic gate by performing multiple logic operations, while fulfilling requirements for cascadability, logic-level restoration, fan-in, and fan-out.

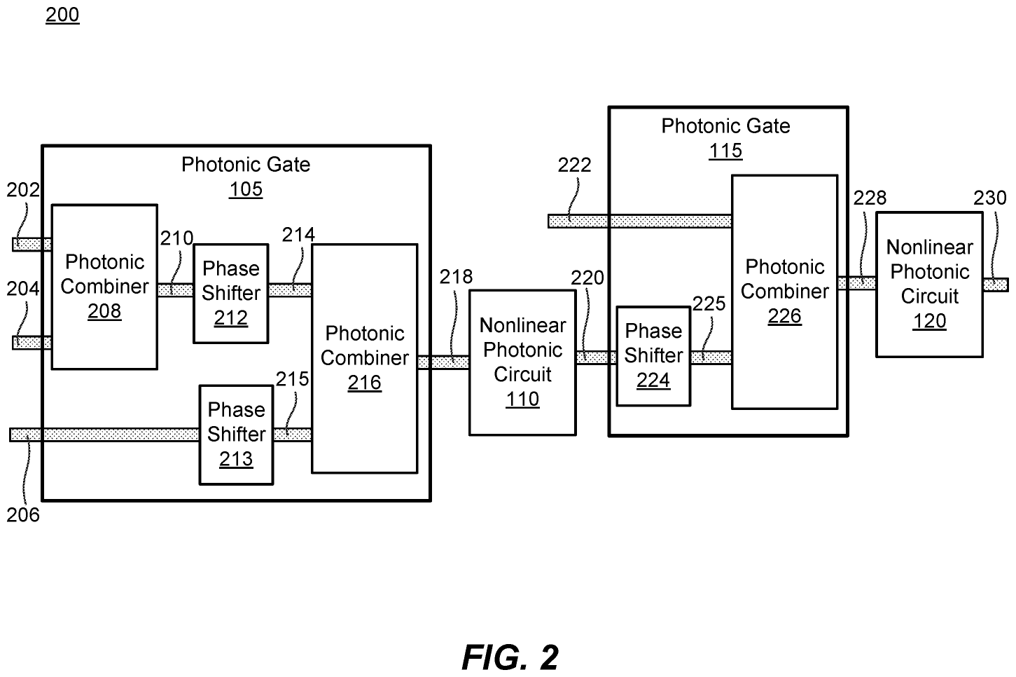

FIG. 2 illustrates an example photonic circuit 200 with a cascading connection of photonic gates and nonlinear photonic circuit, in accordance with some embodiments. The photonic circuit 200 may include the first photonic gate 105, the first nonlinear photonic circuit 110, the second photonic gate 115, and the second nonlinear photonic circuit 120. The photonic circuit 200 may receive a photonic input signal 202 at a first input port of the photonic circuit 200 and a photonic input signal 204 at a second input port of the photonic circuit 200. Other input ports of the photonic circuit 200 may be bias signal ports, each coupled to a respective signal line for a bias signal source. The photonic circuit 200 may include fewer or additional components not shown in FIG. 2, such as, but not limited to, additional phase shifters for compensation of fabrication variations, linear photonic amplifiers, photonic attenuators, photonic phase thresholders, and/or photonic amplitude thresholders.

The photonic circuit 200 may generate a photonic output signal 230 based at least in part on the photonic input signal 202 and the photonic input signal 204. The photonic input signals 202, 204 may be embodiments of the photonic input signals 102₁, . . . , 102_{M} for M=2, and the photonic output signal 230 may be an embodiment of the photonic output signals 112₁, . . . 112_{N} for N=1. The photonic input signals 202 and 204 may be generated by lasers coupled to the first and second input ports of the photonic circuit 200. Alternatively, the photonic input signals 202 and 204 may be generated by one or more photonic circuits having one or more output ports coupled to the first and second input ports of the photonic circuit 200. Each of the photonic input signals 202, 204 may be a light signal of corresponding input amplitudes (that each corresponds to logical “1” or logical “0”), corresponding input phases and/or corresponding input modes (i.e., input light spatial distribution and/or input wavelengths) injected into each of the first and second input ports of the photonic circuit 200.

The first photonic gate 105 may include a photonic combiner 208, a phase shifter 212, a phase shifter 213, and a photonic combiner 216. Input ports of the photonic combiner 208 may be coupled to the first and second input ports of the first photonic gate 105. An output port of the photonic combiner 208 may be coupled to an input port of the phase shifter 212, and an output port of the phase shifter 212 may be coupled to a first input port of the photonic combiner 216. An input port of the phase shifter 213 may be coupled to a third input port (e.g., bias signal port) of the photonic circuit 200, and an output port of the phase shifter 213 may be coupled to a second input port of the photonic combiner 216. An output port of the photonic combiner 216 may be coupled to an input port of the first nonlinear photonic circuit 110. An output port of the first nonlinear photonic circuit 110 may be coupled to a first input port of the second photonic gate 115.

The second photonic gate 115 may include a phase shifter 224 and a photonic combiner 226. An input port of the phase shifter 224 may be coupled to the first input port of the second photonic gate 115. An output port of the phase shifter 224 may be coupled to a first input port of the photonic combiner 226, and a second input port of the photonic combiner may be coupled to a bias signal port of the second photonic gate 115. An output port of the photonic combiner 226 may be coupled to an output port of the second photonic gate 115. The output port of the second photonic gate 115 may be coupled to an input port of the second nonlinear photonic circuit 120. And an output port of the second nonlinear photonic circuit 120 may represent an output port of the photonic circuit 200. It is noted that the input/output ports may be coupled through signal transmission lines (or signal lines). Each of the first and second photonic gates 105 and 115 may include fewer or additional components not shown in FIG. 2, such as, but not limited to, additional phase shifters for compensation of fabrication variations, linear photonic amplifiers, photonic attenuators, and/or photonic amplitude thresholders.

The photonic combiner 208 may receive, at its first input port, the photonic input signal 202. The photonic combiner 208 may further receive, at its second input port, the photonic input signal 204. The set of input ports of the photonic combiner 208 may represent, e.g., a set of waveguides, a set of waveguide polarizations, a set of waveguide modes, a set of light wavelengths, etc. The set of input ports of the photonic combiner 208 may also represent the first and second input ports of the first photonic gate 105. The photonic combiner 208 may generate a photonic signal 210 by combining the photonic input signal 202 and the photonic input signal 204. The photonic signal 210 may be output at an output port of the photonic combiner 208. The output port of the photonic combiner 208 may represent, e.g., a waveguide, a waveguide polarization, a waveguide mode, a light wavelength, a signal radiated by the photonic combiner 208, etc. The photonic signal 210 generated by the photonic combiner 208 may be passed to the phase shifter 212.

The phase shifter 212 may receive the photonic signal 210 at an input port of the phase shifter 212. The input port of the phase shifter 212 may represent, e.g., a waveguide, a waveguide polarization, a waveguide mode, a light wavelength, etc. The phase shifter 212 is a linear photonic component that generates a photonic signal 214 by shifting a phase of the received photonic signal 210. For example, the phase shifter 212 may apply a phase shift of n radians to the photonic signal 210, i.e., the photonic signal 214 may represent an inverted version of the photonic signal 210. The photonic signal 214 may be output at an output port of the phase shifter 212. The output port of the phase shifter 212 may represent, e.g., a waveguide, a waveguide polarization, a waveguide mode, a light wavelength, a signal radiated by the phase shifter 212, etc. The photonic signal 214 generated by the phase shifter 212 may be passed to the photonic combiner 216.

The phase shifter 213 may receive a bias signal at an input port of the phase shifter 213. The input port of the phase shifter 213 may represent, e.g., a waveguide, a waveguide polarization, a waveguide mode, a light wavelength, etc. The bias signal 206 that is input to the phase shifter 213 is a light signal of a defined amplitude level that is constant over time. The bias signal 206 may be generated by, e.g., a photonic local oscillator coupled to the input port of the phase shifter 213 (not shown in FIG. 2). The phase shifter 213 is a linear photonic component that generates a photonic signal 215 by shifting a phase of the received bias signal 206. For example, the phase shifter 213 may apply a phase shift of π radians to the bias signal 206, i.e., the photonic signal 215 may represent an inverted version of the bias signal 206. The photonic signal 215 may be output at an output port of the phase shifter 213. The output port of the phase shifter 213 may represent, e.g., a waveguide, a waveguide polarization, a waveguide mode, a light wavelength, a signal radiated by the phase shifter 213, etc. The photonic signal 215 generated by the phase shifter 213 may be passed to the photonic combiner 216.

The photonic combiner 216 may receive, at its first input port, the photonic signal 214 generated by the phase shifter 212. The photonic combiner 216 may further receive, at its second input port, the photonic signal 215 generated by the phase shifter 213. The set of input ports of the photonic combiner 216 may represent, e.g., a set of waveguides, a set of waveguide polarizations, a set of waveguide modes, a set of light wavelengths, etc. The photonic combiner 216 may generate a photonic signal 218 by combining the photonic signal 214 and the photonic signal 215. The photonic signal 218 may be output at an output port of the photonic combiner 216. The output port of the photonic combiner 216 may represent, e.g., a waveguide, a waveguide polarization, a waveguide mode, a light wavelength, a signal radiated by the photonic combiner 216, etc. The output port of the photonic combiner 216 may also represent an output port of the first photonic gate 105. The photonic signal 218 generated by the first photonic gate 105 may be an embodiment of the photonic signals 104₁, . . . , 104_{P} for P=1. The photonic combiner 216 may pass the photonic signal 218 to the nonlinear photonic circuit 110.

As aforementioned in relation to FIG. 1, the first nonlinear photonic circuit 110 may generate a photonic signal 220 at its output port by applying a nonlinear transfer function of the first nonlinear photonic circuit 110 to the photonic signal 218, and an operating regime of the first nonlinear photonic circuit 110 (i.e., a region of the nonlinear transfer function) depends on a level of each amplitude of the photonic signal 218. When the phase shifters 212, 213 do not apply a phase shift (i.e., both apply phase shifts of 0 radians) and the bias signal 206 is equal to zero, then the photonic combiner 208, the phase shifter 212, the phase shifter 213, the photonic combiner 216, and the first nonlinear photonic circuit 110 may together operate as a nonlinear AND photonic logic gate and the photonic signal 220 may represent a result of the AND logic function of the photonic input signals 202 and 204. Alternatively, when the phase shifter 212 applies a phase shift of π radians, the phase shifter 213 does not apply a phase shift (i.e., applies phase shift of 0 radians), and the bias signal 206 is equal to the largest value of all elements in a truth table of the first photonic gate 105, then the photonic combiner 208, the phase shifter 212, the phase shifter 213, the photonic combiner 216, and the first nonlinear photonic circuit 110 may together operate as a nonlinear NOR photonic logic gate and the photonic signal 220 may represent a result of the NOR logic function of the photonic input signals 202 and 204. Alternatively, when the phase shifter 212 does not apply a phase shift (i.e., applies phase shift of 0 radians), the phase shifter 213 applies a phase shift of π radians, and the bias signal 206 is equal to the largest value of all elements in the truth table of the first photonic gate 105, then the photonic combiner 208, the phase shifter 212, the phase shifter 213, the photonic combiner 216, and the first nonlinear photonic circuit 110 may together operate as a nonlinear XOR photonic logic gate and the photonic signal 220 may represent a result of the XOR logic function of the photonic input signals 202 and 204.

Given that the first photonic gate 105 may include only linear photonic elements, the photonic signal 218 generated by the first photonic gate 105 may have one or more accumulative errors (e.g., one or more phase errors, one or more amplitude errors, one or more mode errors, one or more wavelength errors, one or more bit errors, some other type of error, or some combination thereof). The first nonlinear photonic circuit 110 coupled to the output port of the first photonic gate 105 may correct the one or more accumulative errors in the photonic signal 218, i.e., the photonic signal 220 generated by the first nonlinear photonic circuit 110 may be an error-free photonic signal with restored logic levels. The photonic signal 220 may be an embodiment of the photonic signals 106₁, . . . , 106_{R} for R=1. The first nonlinear photonic circuit 110 may pass the photonic signal 220 to the phase shifter 224 of the second photonic gate 115. Additionally, the first nonlinear photonic circuit 110 may pass the photonic signal 220 to one or more other photonic circuits (not shown in FIG. 2). Hence, the output port of the first nonlinear photonic circuit 110 may also represent a first output port of the photonic circuit 200.

The phase shifter 224 may receive the photonic signal 220 at an input port of the phase shifter 224. The input port of the phase shifter 224 may represent, e.g., a waveguide, a waveguide polarization, a waveguide mode, a light wavelength, etc. The input port of the phase shifter 224 may also represent a first input port of the second photonic gate 115. The phase shifter 224 is a linear photonic component that generates a photonic signal 225 by shifting a phase of the received photonic signal 220. For example, the phase shifter 224 may apply a phase shift of π radians to the photonic signal 220, i.e., the photonic signal 225 may represent an inverted version of the photonic signal 220. The photonic signal 225 may be output at an output port of the phase shifter 224. The output port of the phase shifter 224 may represent, e.g., a waveguide, a waveguide polarization, a waveguide mode, a light wavelength, a signal radiated by the phase shifter 224, etc. The photonic signal 225 generated by the phase shifter 224 may be passed to the photonic combiner 226.

The photonic combiner 226 may receive, at its first input port, the photonic signal 225 generated by the phase shifter 224. The photonic combiner 226 may further receive, at its second input port, a bias signal 222. The set of input ports of the photonic combiner 226 may represent, e.g., a set of waveguides, a set of waveguide polarizations, a set of waveguide modes, a set of light wavelengths, etc. The second input port of the photonic combiner 226 may also represent a second input port of the second photonic gate 115. The bias signal 222 that is input to the photonic combiner 226 is a light signal of a defined amplitude level that is constant over time. The bias signal 222 may be generated by, e.g., a photonic local oscillator coupled to the second input port of the photonic combiner 226 (not shown in FIG. 2). The photonic combiner 226 may generate a photonic signal 228 by combining the photonic signal 225 and the bias signal 222. The photonic signal 228 may be output at an output port of the photonic combiner 226. The output port of the photonic combiner 226 may represent, e.g., a waveguide, a waveguide polarization, a waveguide mode, a light wavelength, a signal radiated by the photonic combiner 226, etc. The output port of the photonic combiner 226 may also represent an output port of the second photonic gate 115. The photonic signal 226 may be an embodiment of the photonic signals 108₁, . . . , 108_{T} for T=1. The photonic combiner 226 may pass the photonic signal 228 to the second nonlinear photonic circuit 120.

As aforementioned in relation to FIG. 1, the second nonlinear photonic circuit 120 may generate the photonic output signal 230 at its output port by applying a nonlinear transfer function of the second nonlinear photonic circuit 120 to the photonic signal 228, and an operating regime of the second nonlinear photonic circuit 120 (i.e., a region of the nonlinear transfer function) depends on a level of each amplitude of the photonic signal 228. Given that the second photonic gate 115 may include only linear photonic elements, the photonic signal 228 generated by the second photonic gate 115 may include one or more accumulative errors (e.g., one or more phase errors, one or more amplitude errors, one or more mode errors, one or more wavelength errors, one or more bit errors, some other type of error, or some combination thereof). The second nonlinear photonic circuit 120 coupled to the output port of the second photonic gate 115 may correct the one or more accumulative errors in the photonic signal 228, i.e., the photonic output signal 230 generated by the second nonlinear photonic circuit 120 may be an error-free photonic signal with restored logic levels. The photonic output signal 230 may be an embodiment of the photonic signals 112₁, . . . , 112_{N} for N=1.

It should be noted that the photonic combiner 208, the phase shifter 212, the phase shifter 213, the photonic combiner 216, the first nonlinear photonic circuit 110, the phase shifter 224, the photonic combiner 226, and the second nonlinear photonic circuit 120 may together operate as a nonlinear NAND or OR photonic logic gates, i.e., the photonic output signal 230 may represent a result of the NAND or OR logic function of the photonic input signals 202 and 204. The photonic circuit 200 may pass the photonic output signal 230 to one or more other photonic circuits (not shown in FIG. 2). Hence, the output port of the second nonlinear photonic circuit 120 may also represent a second output port of the photonic circuit 200. By providing multiple error-free logic functions (e.g., the NAND, AND, NOR, OR, or XOR logic functions), the photonic circuit 200 operates as a cascadable “universal photonic gate” with restored logic levels, while having a fan-in factor (e.g., number of photonic gates supplying input ports of the photonic circuit 200) and a fan-out factor (e.g., number of photonic gates being driven by output ports of the photonic circuit 200) above threshold levels.

It should be noted that all photonic signals within the photonic circuit 200 (i.e., photonic signals 202, 204, 206, 210, 214, 215, 218, 220, 222, 225, 228, 230) may be passed to corresponding photonic components of the photonic circuit 200 via silicon waveguides. Thus, all connections between photonic components of the photonic circuit 200 may be implemented as silicon waveguides. The photonic combiner 208, the phase shifter 212, the phase shifter 213, the photonic combiner 216, the phase shifter 224, and the photonic combiner 226 may be implemented as silicon photonic circuits. The nonlinear photonic circuits 110, 120 may be implemented in a III-V platform containing an alloy composed of semiconductors from groups III and V in the periodic table (e.g., InP, InAs, GaAs, GaN, and InSb) using a saturated absorber, SOA, saturated gain, some other type of amplitude thresholder, or some combination thereof. In such cases, the nonlinear photonic circuits 110, 120 may be heterogeneously integrated with the silicon photonic circuits of the photonic circuit 200. Alternatively, the nonlinear photonic circuits 110, 120 may be implemented with electro-optical devices such as photodetectors, modulators, complementary metal-oxide-semiconductor transimpedance amplifiers (CMOS TIAs), and any other element that improves the design. In such cases, the nonlinear photonic circuits 110, 120 may be CMOS monolithically integrated with the silicon photonic circuits of the photonic circuit 200. Alternatively or additionally, the nonlinear photonic circuits 110, 120 may also be fiber attached, micro-transfer printed, flip-chipped, optically and/or electronically wire-bonded to other components of the photonic circuit 200.

### Transfer Functions and Configurations of Nonlinear Photonic Circuit

FIG. 3A illustrates an example graph of a transfer function of the first nonlinear photonic circuit 110 and of the second nonlinear photonic circuit 120 represented as a three-region piece-wise function 305, in accordance with some embodiments. The piece-wise transfer function 305 can be also referred to as a “piece-wise sigmoid function”. Each of the first nonlinear photonic circuit 110 and the second nonlinear photonic circuit 120 featuring the piece-wise transfer function 305 may be implemented as one or more SOA-based amplitude thresholders, one or more saturable absorber-based amplitude thresholders, one or more photonic resonator-based amplitude thresholders, some other type of nonlinear amplitude thresholder, or some combination thereof.

Each of the first nonlinear photonic circuit 110 and the second nonlinear photonic circuit 120 having the transfer function represented by the piece-wise function 305 may operate in a region 310 associated with a first operating regime and output amplitude values close to zero, in a region 315 associated with a second operating regime, or in a region 320 associated with a third operating regime and output amplitude values that are phase shifted by π radians related to amplitude values input into the first nonlinear photonic circuit 110 (or the second nonlinear photonic circuit 120). An operating regime of the first nonlinear photonic circuit 110 (or the second nonlinear photonic circuit 120) may depend on an amplitude level of a photonic signal that is input into the first nonlinear photonic circuit 110 (i.e., on a level of the “input amplitude”) or into the second nonlinear photonic circuit 120.

In some embodiments, the regions 310 and 320 are approximately nonlinear regions of the piece-wise function 305, and the region 315 is approximately linear region of the piece-wise function 305. When the first nonlinear photonic circuit 110 (or the second nonlinear photonic circuit 120) operates in the region 310, an amplitude of a photonic signal output by the first nonlinear photonic circuit 110 (or by the second nonlinear photonic circuit 120) (i.e., “output amplitude”) may be saturated to a first saturation level (e.g., approximately equal to zero). When the first nonlinear photonic circuit 110 (or the second nonlinear photonic circuit 120) operates in the region 320, the output amplitude may be saturated to a second saturation level that is higher than the first saturation level and phase shifted by π radians relative to the input amplitude. When the first nonlinear photonic circuit 110 (or the second nonlinear photonic circuit 120) operates in the region 315, the output amplitude may not be saturated. Instead, the output amplitude may be determined based on a gain (i.e., slope) of the piece-wise function 305 in the region 315.

FIG. 3B illustrates an example graph 350 of a transfer function of the first nonlinear photonic circuit 110 (or of the second nonlinear photonic circuit 120) represented as a three-region piece-wise function, in accordance with some embodiments. The piece-wise function ƒ(x) can be also referred to as a “piece-wise sigmoid function”. The first nonlinear photonic circuit 110 (or the second nonlinear photonic circuit 120) featuring the piece-wise transfer function ƒ(x) may be implemented as one or more SOA-based amplitude thresholders, one or more saturable absorber-based amplitude thresholders, one or more photonic resonator-based amplitude thresholders, some other type of nonlinear amplitude thresholder, or some combination thereof.

The general nonlinearity of the first nonlinear photonic circuit 110 (or of the second nonlinear photonic circuit 120) may be represented by the piece-wise function ƒ(x) that has three slopes, i.e., the first slope α₁=(y₁−y₀)/(x₁−x₀) on a first interval of input amplitudes x∈[x₀, x₁], the second slope α₂=(y₂−y₁)/(x₂−x₁) on a second interval of input amplitudes x∈(x₁, x₂], and the third slope α₃=(y₃−y₂)/(x₃−x₂) on a third interval of input amplitudes x∈(x₂, x₃]. Note that the first slope α₁, the second slope α₂ and the third slope α₃ may be calculated using intensity values of output amplitudes, |y₁|², [y₂|², |y₃|². Thus, the piece-wise transfer function ƒ(x) can be defined as:

$$f ( x ) = \{ \begin{matrix}{α}_{1} x + {b}_{1} , if x ∈ [ {x}_{0} , {x}_{1} ] \\ {α}_{2} x + {b}_{2} , if x ∈ ( {x}_{1} , {x}_{2} ] \\ {α}_{3} x + {b}_{3} , if x ∈ ( {x}_{2} , {x}_{3} ]\end{matrix} , \qquad ( 1 )$$

where the values of parameters b₁, b₂ and b₃ are defined as in FIG. 3B. The first interval of input amplitudes x∈[x₀, x₁] may define operation of the first nonlinear photonic circuit 110 (or of the second nonlinear photonic circuit 120) in a first region associated with a first operating regime (e.g., the region 310), the second interval of input amplitudes x∈(x₁, x₂] may define operation of the first nonlinear photonic circuit 110 (or of the second nonlinear photonic circuit 120) in a second region associated with a second operating regime (e.g., the region 315); and the third interval of input amplitudes x∈(x₂, x₃] may define operation of the first nonlinear photonic circuit 110 (or of the second nonlinear photonic circuit 120) in a third region associated with a third operating regime (e.g., the region 320).

Note that, in ideal case, it would hold that α₁→0, α₂→1, α₃→0; however, in general, α₂>>α₁, α₂>>α₃, α₃≈α₁. Thus, in general, it holds that y₁≈y₀, and the output amplitude value of y₁ (or y₀) may represent a first saturation level when the first nonlinear photonic circuit 110 (or the second nonlinear photonic circuit 120) operates in the first region. The input amplitude value x greater than or equal to x₀ and lower than or equal to x₁ may represent an input threshold level for operating the first nonlinear photonic circuit 110 (or the second nonlinear photonic circuit 120) in the second region. Furthermore, in general, it holds that |y₃|²≈|y₂|² (i.e., intensities of y₂ and y₃ are approximately same), but the phases of y₂ and y₃ can be different (e.g., the phase of y₂ can be a radians, and the phase of y₃ can be 3π/2 radians). The output amplitude value of y₃ (or y₂) may represent a second saturation level higher than the first saturation level when the first nonlinear photonic circuit 110 (or the second nonlinear photonic circuit 120) operates in the third region. The input amplitude value of x₂ may represent an input threshold level for operating the first nonlinear photonic circuit 110 (or the second nonlinear photonic circuit 120) in the third region. The first nonlinear photonic circuit 110 (or the second nonlinear photonic circuit 120) may operate in the third region defined when the input amplitude is greater than the threshold level of x₂ and less than or equal to x₃, where the input amplitude value of x₃ may represent a largest input amplitude value for which the first nonlinear photonic circuit 110 (or the second nonlinear photonic circuit 120) is configured to correctly operate.

In one or more embodiments, for implementing the piece-wise nonlinear function defined by equation (1), the photonic circuit 100 may include a cascaded connection of a SOA-based amplitude thresholder and saturable absorber, e.g., the first nonlinear photonic circuit 110 may include a SOA-based amplitude thresholder and the second nonlinear photonic circuit 120 may include a saturable absorber. In such cases, the first nonlinear photonic circuit 110 including the SOA-based amplitude thresholder may provide implementation of the region where x∈(x₂, x₃] (i.e., the ceiling thresholding region of the piece-wise nonlinear function), and the second nonlinear photonic circuit 120 including the saturable absorber may provide implementation of the region x∈(x₁, x₂] (i.e., the linear region of the piece-wise nonlinear function) and the region x∈[x₀, x₁] (i.e., the floor thresholding region of the piece-wise nonlinear function).

Note that values of y₂ may depend on a current applied to a SOA-based amplitude thresholder of the first nonlinear photonic circuit 110 and the input power (i.e., intensity) of x₂. For implementation of AND, NAND, OR and NOR photonic logic gates at the photonic circuit 100, similar current and input power can be applied to the first nonlinear photonic circuit 110, when the nonlinearity of the first nonlinear photonic circuit 110 is performed by the SOA-based amplitude thresholder operating in the ceiling thresholding region. In such cases, the second nonlinear photonic circuit 120 may operate in the linear regime of the saturable absorber for amplification of a photonic signal output by the second photonic gate 115. For implementation of XOR and XNOR photonic logic gates at the photonic circuit 100, a different set of current and input power needs applied to the first nonlinear photonic circuit 110, when the nonlinearity of the first nonlinear photonic circuit 110 is performed by the SOA-based amplitude thresholder operating in the ceiling thresholding region. In such cases, the second nonlinear photonic circuit 120 may operate in the floor thresholding region of the saturable absorber. For implementing XOR and XNOR photonic logic gates at the photonic circuit 100, both ceiling thresholding (e.g., achieved by the SOA-based amplitude thresholder of the first nonlinear photonic circuit 110) and floor thresholding (e.g., achieved by the saturable absorber of the second nonlinear photonic circuit 120) may need to be applied to obtain a clean binary output at an output port of the second nonlinear photonic circuit 120.

FIG. 4A illustrates examples of different configurations of the first nonlinear photonic circuit 110 (or of the second nonlinear photonic circuit 120), in accordance with some embodiments. Each configuration of the first nonlinear photonic circuit 110 (or of the second nonlinear photonic circuit 120) in FIG. 4A may feature a corresponding nonlinear transfer function having a same general piece-wise (e.g., sigmoid function) representation (e.g., as shown in FIG. 4B). Although FIG. 4A shows various different configurations of the first nonlinear photonic circuit 110 (or of the second nonlinear photonic circuit 120), it should be understood that some other configurations of the first nonlinear photonic circuit 110 (or of the second nonlinear photonic circuit 120) that are not shown in FIG. 4A are possible.

A nonlinear photonic circuit 400 in FIG. 4A may include a single saturable absorber 405. Alternatively, instead of the single saturable absorber 405, the nonlinear photonic circuit 400 may include a single SOA-based amplitude thresholder (referred to as “SOA” in FIG. 4A). The nonlinear photonic circuit 400 may be an embodiment of the first nonlinear photonic circuit 110 (or of the second nonlinear photonic circuit 120). A nonlinear photonic circuit 410 in FIG. 4A may include a SOA 415 and a saturable absorber 420, where an input port of the saturable absorber 420 is coupled to an output port of the SOA 415. The nonlinear photonic circuit 410 may be an embodiment of the first nonlinear photonic circuit 110 (or of the second nonlinear photonic circuit 120). A nonlinear photonic circuit 425 in FIG. 4A may include a pair of concatenated saturable absorbers 430 and 435, where an input port of the saturable absorber 435 is coupled to an output port of the saturable absorber 430. The nonlinear photonic circuit 425 may be an embodiment of the first nonlinear photonic circuit 110 (or of the second nonlinear photonic circuit 120).

A nonlinear photonic circuit 440 in FIG. 4A may include a saturable absorber 445 and a SOA 450, where an input port of the SOA 450 is coupled to an output port of the saturable absorber 445. The nonlinear photonic circuit 440 may be an embodiment of the first nonlinear photonic circuit 110 (or of the second nonlinear photonic circuit 120). A nonlinear photonic circuit 455 in FIG. 4A may include a SOA 460, a saturable absorber 465 and a SOA 470, where an input port of the saturable absorber 465 is coupled to an output port of the SOA 460 and an input port of the SOA 470 is coupled to an output port of the saturable absorber 465. The nonlinear photonic circuit 455 may be an embodiment of the first nonlinear photonic circuit 110 (or of the second nonlinear photonic circuit 120).

FIG. 4B illustrates an example graph 475 of a piece-wise transfer function 480 of a configuration of a nonlinear photonic circuit in FIG. 4A, in accordance with some embodiments. The configuration of the nonlinear photonic circuit having the transfer function represented by the piece-wise transfer function 480 may operate in a region 485 associated with a first operating regime, in a region 490 associated with a second operating regime, or in a region 495 associated with a third operating regime, which depends on an amplitude level of a photonic signal that is input into the corresponding configuration of the nonlinear photonic circuit in FIG. 4A (i.e., on a level of the “input amplitude”). In some embodiments, the regions 485 and 495 are approximately nonlinear regions of the piece-wise transfer function 480, and the region 490 is approximately linear region of the piece-wise transfer function 480. When the nonlinear photonic circuit operates in the region 485, an amplitude of a photonic signal output by the nonlinear photonic circuit (i.e., “output amplitude”) may be saturated to a first saturation level. When the nonlinear photonic circuit operates in the region 495, the output amplitude may be saturated to a second saturation level that is higher than the first saturation level. When the nonlinear photonic circuit operates in the region 490, the output amplitude may not be saturated but instead determined based on a gain (i.e., slope) of the piece-wise transfer function 480 in the region 490.

Each configuration of the nonlinear photonic circuit in FIG. 4A (i.e., each of the nonlinear photonic circuits 400, 410, 425, 540, 555) may feature a different piece-wise transfer function 480. Each of the nonlinear photonic circuits 400, 410, 425, 440, 455 may feature a piece-wise transfer function 480 with a unique set of slopes. Additionally or alternatively, each of the nonlinear photonic circuits 400, 410, 425, 440, 455 may feature a different region 485, a different region 490 and/or a different region 495. This is because each of the nonlinear photonic circuits 400, 410, 425, 440, 455 may require a different range of input amplitudes to operate in a corresponding region 485, 490, 495. Additionally or alternatively, each of the nonlinear photonic circuits 400, 410, 425, 440, 455 may feature different saturation levels when operating in the region 485 and/or the region 495. In one or more embodiments, the piece-wise transfer function 480 includes a gain (i.e., increase) in an output amplitude and output optical values are phase shifted by π radians for all input amplitudes or individual input amplitudes. In one or more other embodiments, the piece-wise transfer function 480 does not provide any gain (i.e., increase) when generating an output amplitude.

### Example Process Flow

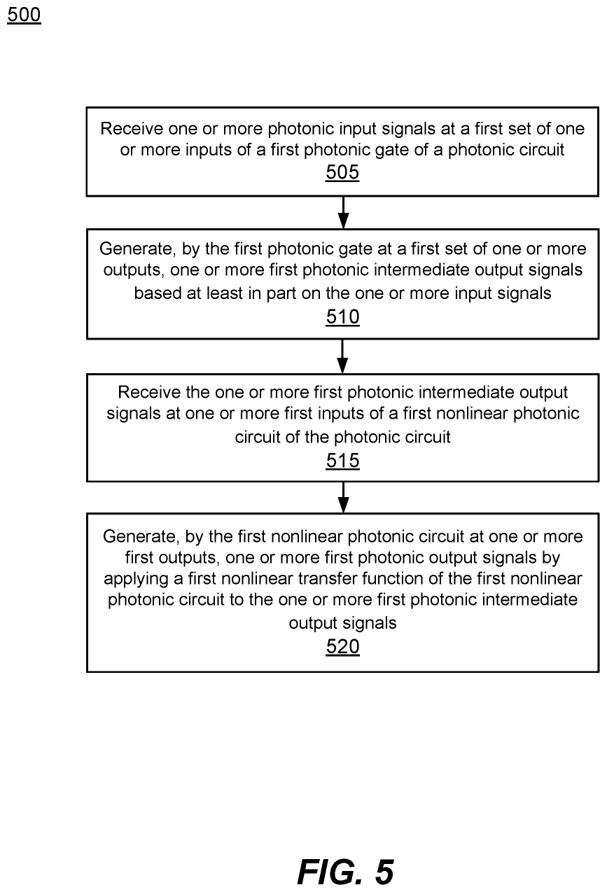

FIG. 5 is a flowchart illustrating an example method 500 for operating a photonic circuit as a universal photonic gate, in accordance with some embodiments. The operations of method 500 may be performed at, e.g., the photonic circuit 100 or the photonic circuit 200. The photonic circuit may be part of a photonic processor that includes the photonic circuit and a set of one or more other photonic circuits (e.g., cascading connection of two or more (or at least two) of the photonic circuits). The photonic circuit may be deployed in a computing system (e.g., a photonic processor) that can further include a non-transitory computer-readable storage medium (e.g., optical, electrical, or electro-optical memory) for storing computer-executable instructions and data. The computing system may be an optical computing system (i.e., silicon photonics platform), an electronic computing system, some other type of computing system, or some combination thereof.

The photonic circuit receives 505 one or more photonic input signals (e.g., the one or more photonic input signals 102₁, . . . , 102_{M} or the photonic input signals 202, 204) at a first set of one or more inputs of a first photonic gate (e.g., the first photonic gate 105). The photonic circuit generates 510, by the first photonic gate at a first set of one or more outputs, one or more first photonic intermediate output signals (e.g., any of the one or more photonic signals 104₁, . . . , 104_{P} or the photonic signal 218) based at least in part on the one or more photonic input signals.

The photonic circuit receives 515 the one or more first photonic intermediate output signals at one or more first inputs of a first nonlinear photonic circuit (e.g., the first nonlinear photonic circuit 110). The photonic circuit generates 520, by the first nonlinear photonic circuit at one or more first outputs, one or more first photonic output signals (e.g., the one or more photonic signals 106₁, . . . , 106_{R} or the photonic output signal 220) by applying a first nonlinear transfer function of the first nonlinear photonic circuit to the one or more first photonic intermediate output signals.

The first photonic gate may include a first photonic combiner (e.g., the photonic combiner 208) having a first input configured to receive a first photonic input signal of the one or more photonic inputs signals and a second input configured to receive a second photonic input signal of the one or more photonic inputs signals. The first photonic gate may further include a first phase shifter (e.g., the phase shifter 212) coupled to an output of the first photonic combiner. The first photonic gate may further include a second phase shifter (e.g., the phase shifter 213) having an input coupled to an input of the first set of one or more inputs and configured to receive a bias signal having an amplitude value that is constant over time. The first photonic gate may further include a second photonic combiner (e.g., the photonic combiner 216) having a first input coupled to an output of the first phase shifter and a second input coupled to an output of the second phase shifter, an output of the second photonic combiner representing an output of the first set of one or more outputs.

The photonic circuit may instruct the first phase shifter to apply a first phase shift, instruct the second phase shifter to apply a second phase shift different from the first phase shift, and set an amplitude value of a bias signal input to the second phase shifter to a defined value. A logical function of a cascading connection of the first photonic gate and the first nonlinear photonic circuit may depend on the first phase shift, the second phase shift, and the amplitude value of the bias signal. The photonic circuit may be part of a photonic processor including the photonic circuit and a set of one or more other photonic circuits, and one or more inputs of the set of one or other photonic circuits may be coupled to the one or more first outputs of the first nonlinear photonic circuit.

The photonic circuit may instruct a second photonic gate of the photonic circuit (e.g., the second photonic gate 115) to receive the one or more first photonic output signals at a second set of one or more inputs coupled to the one or more first outputs. The photonic circuit may further instruct the second photonic gate to generate, based at least in part on the one or more first photonic output signals, one or more second photonic intermediate output signals (the one or more photonic signals 108₁, . . . 108_{T} or the photonic signal 228) at a second set of one or more outputs. The photonic circuit may instruct a second nonlinear photonic circuit of the photonic circuit (e.g., the second nonlinear photonic circuit 120) to receive the one or more second photonic intermediate output signals at one or more second inputs coupled to the second set of one or more outputs. The photonic circuit may further instruct the second nonlinear photonic circuit to generate one or more second photonic output signals (e.g., the one or more photonic output signals 112₁, . . . 112_{N} or the photonic output signal 230) at one or more second outputs by applying a second nonlinear transfer function of the second nonlinear photonic circuit to the one or more second photonic intermediate output signals. The photonic circuit may be part of a photonic processor comprising the photonic circuit and a set of one or more other photonic circuits, and one or more inputs of the set of one or other photonic circuits may be coupled to the one or more second outputs of the second nonlinear photonic circuit.

The second photonic gate may include a phase shifter (e.g., the phase shifter 224) coupled to an output of the one or more first outputs of the first nonlinear photonic circuit. The second photonic gate may further include a photonic combiner (e.g., the photonic combiner 226) having a first input coupled to an output of the phase shifter and a second input configured to receive a bias signal (e.g., the bias signal 222) having an amplitude value that is constant over time. An output of the photonic combiner may be coupled to an input of the one or more second inputs of the second nonlinear photonic circuit. A logical function of a cascading connection of the first photonic gate, the first nonlinear photonic circuit, the second photonic gate and the second nonlinear photonic circuit may depend at least in part on phase shifts applied by a pair of phase shifters (e.g., the phase shifters 212, 213) of the first photonic gate and on a phase shift applied by the phase shifter (phase shifter 224) of the second photonic gate.

The photonic circuit may instruct the second nonlinear photonic circuit to saturate the one or more second amplitudes of the one or more second photonic intermediate output signals to a first amplitude level, when the second nonlinear photonic circuit operates in a first operating regime. The photonic circuit may further instruct the second nonlinear photonic circuit to apply a transfer gain of the second nonlinear transfer function to one or more second amplitudes of the one or more second photonic intermediate output signals, when the second nonlinear photonic circuit operates in a second operating regime. The photonic circuit may instruct the first nonlinear photonic circuit to saturate one or more first amplitudes of the one or more first photonic intermediate output signals to a second amplitude level greater than the first amplitude level, when the first nonlinear photonic circuit operates in a third operating regime. The photonic circuit may further instruct the first nonlinear photonic circuit to apply the first nonlinear transfer function by saturating one or more first amplitudes of the one or more first photonic intermediate output signals to one or more defined amplitude levels when generating the one or more first photonic output signals.

In one or more embodiments, the first nonlinear photonic circuit includes a SOA-based amplitude thresholder and the second nonlinear photonic circuit includes a saturable absorber. The saturable absorber operates in a first operating regime defined by a first portion of a cumulative nonlinear transfer function of the first and second nonlinear photonic circuits or in a second operating regime defined by a second portion of the cumulative nonlinear transfer function. The SOA-based amplitude thresholder may operate in a third operating regime defined by a third portion of the cumulative nonlinear transfer function. The SOA-based amplitude thresholder may be configured to operate in the third operating regime based on one or more first amplitudes of the one or more first photonic intermediate output signals generated by the first photonic gate. The saturable absorber may be configured to operate in the first operating regime or the second operating regime based on one or more second amplitudes of the one or more second photonic intermediate output signals generated by the second photonic gate.

The saturable absorber may be configured to apply a transfer gain of the second nonlinear transfer function to one or more second amplitudes of the one or more second photonic intermediate output signals, when the saturable absorber operates in the second operating regime. Alternatively, the saturable absorber may be configured to saturate the one or more second amplitudes of the one or more second photonic intermediate output signals to a first amplitude level, when the saturable absorber operates in the first operating regime. The SOA-based amplitude thresholder may be configured to saturate one or more first amplitudes of the one or more first photonic intermediate output signals to a second amplitude level greater than the first amplitude level, when the SOA-based amplitude thresholder operates in the third operating regime.

In one or more embodiments, the first nonlinear photonic circuit includes one or more amplitude thresholders configured to apply the first nonlinear transfer function by saturating one or more amplitudes of the one or more first photonic intermediate output signals to one or more defined amplitude levels when generating the one or more first photonic output signals. In one or more other embodiments, the first nonlinear photonic circuit includes a cascading connection of one or more saturable absorbers and one or more semiconductor optical amplifier-based amplitude thresholders.

This disclosure presents photonic circuits that operate as universal photonic gates that fulfil requirements for cascadability, logic-level restoration, fan-in, and fan-out. The photonic circuits presented herein can perform multiple logic operations on photonic signals by employing cascading connections of linear photonic gates and nonlinear photonic components.

### Additional Considerations

The disclosed configurations beneficially provide for efficient design of photonic logic gates while substantially reducing a number of required numerical design simulations. Moreover, the circuits noted may be designed and simulated with electronic, electronic-photonic and/or photonic design automation tools (referred to herein as “design automation”) and represented as circuit layouts stored in an electronic library, electronic-photonic library and/or photonic library. The circuit designs may be retrieved and incorporated into designs of chips including the retrieved design.

The design automation may include a set of processes used during the design, verification, and fabrication of an article of manufacture such as an integrated circuit (e.g., photonic integrated circuit) to transform and verify design data and instructions that represent the integrated circuit. Each of these processes can be structured and enabled as multiple modules or operations. These processes may start with the creation of a product idea with information supplied by a designer, information which is transformed to create an article of manufacture that uses a set of design automation processes. When the design is finalized, the design can be taped-out, which is when artwork (e.g., geometric patterns) for the integrated circuit is sent to a fabrication facility to manufacture the mask set, which is then used to manufacture the integrated circuit. After tape-out, a die (e.g., photonic die) is fabricated and packaging and assembly processes are performed to produce the finished integrated circuit.

During system design as part of design automation, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification as part of design automation, modules or components in the integrated circuit are specified in one or more description languages and the specification is checked for functional accuracy. For example, the components of the integrated circuit may be verified to generate outputs that match the requirements of the specification of the integrated circuit or system being designed. Functional verification may use simulators and other programs such as testbench generators, static hardware description language (‘HDL’) checkers, and formal verifiers. In some embodiments, special systems of components referred to as ‘emulators’ or ‘prototyping systems’ are used to speed up the functional verification. During design planning as part of design automation, an overall floor plan for the integrated circuit is constructed and analyzed for timing and top-level routing.

During layout or physical implementation as part of design automation, physical placement (positioning of circuit components) and routing (connection of the circuit components) occurs, and the selection of cells from a library to enable specific logic functions can be performed. As used herein, the term ‘cell’ may specify a set of components and interconnections that provides a Boolean logic function (e.g., AND, OR, NOT, XOR, etc.) or a storage function (such as a flipflop or latch). As used herein, a circuit ‘block’ may refer to two or more cells. Both a cell and a circuit block can be referred to as a module or component and are enabled as both physical structures and in simulations. Parameters are specified for selected cells (based on ‘standard cells’) such as size and made accessible in a database for use by design automation products.

The foregoing description of the embodiments of the disclosure has been presented for the purpose of illustration; it is not intended to be exhaustive or to limit the disclosure to the precise forms disclosed. Persons skilled in the relevant art can appreciate that many modifications and variations are possible in light of the above disclosure.

Some portions of this description describe the embodiments of the disclosure in terms of algorithms and symbolic representations of operations on information. These algorithmic descriptions and representations are commonly used by those skilled in the data processing arts to effectively convey the substance of their work to others skilled in the art. While described functionally, computationally, or logically, these operations are understood to be implemented by computer programs or equivalent electrical circuits, microcode, or the like. Furthermore, at times, it has also proven convenient to refer to these arrangements of operations as modules without loss of generality. The described operations and associated modules can be embodied in software, firmware, hardware, or some combination thereof.

Any steps, operations, or processes described herein can be performed or implemented with one or more hardware or software modules, alone or in combination with other devices. In one embodiment, a software module is implemented with a computer program product comprising a computer-readable medium containing computer program code, which a computer processor can execute for performing any or all of the steps, operations, or processes described herein.

Embodiments of the disclosure can also relate to an apparatus for performing the operations herein. This apparatus can be specially constructed for the required purposes, and/or it can comprise a general-purpose computing device selectively activated or reconfigured by a computer program stored in the computer. Such a computer program can be stored in a non-transitory, tangible computer-readable storage medium or any media suitable for storing electrical instructions coupled to a computer system bus. Furthermore, any computing systems referred to in the specification can include a single processor or architectures employing multiple processor designs for increased computing capability.

Some embodiments of the present disclosure can further relate to a system comprising a processor, at least one computer processor, and a non-transitory computer-readable storage medium. The storage medium can store computer-executable instructions, which, when executed by the compiler operating on at least one computer processor, cause at least one computer processor to be operable for performing the operations and techniques described herein.

Finally, the language used in the specification has been principally selected for readability and instructional purposes, and it has not been selected to delineate or circumscribe the inventive subject matter. It is therefore intended that the scope of the disclosure be limited not by this detailed description but rather by any claims that issue on an application based hereon. Accordingly, the disclosure of the embodiments is intended to be illustrative, but not to limit the scope of the disclosure, which is set forth in the following claims.

What is claimed is:

1. A photonic circuit, comprising:
a first photonic gate having a first set of one or more inputs and a first set of one or more outputs, the first set of one or more inputs configured to receive one or more photonic input signals, the first photonic gate configured to generate, based at least in part on the one or more photonic input signals, one or more first photonic intermediate output signals at the first set of one or more outputs; and
a first nonlinear photonic circuit having one or more first inputs and one or more first outputs, the one or more first inputs coupled to the first set of one or more outputs and configured to receive the one or more first photonic intermediate output signals, the first nonlinear photonic circuit configured to generate one or more first photonic output signals at the one or more first outputs by applying a first nonlinear transfer function of the first nonlinear photonic circuit to the one or more first photonic intermediate output signals.

2. The photonic circuit of claim 1, wherein the first photonic gate comprises:
a first photonic combiner having a first input configured to receive a first photonic input signal of the one or more photonic inputs signals and a second input configured to receive a second photonic input signal of the one or more photonic inputs signals;
a first phase shifter coupled to an output of the first photonic combiner;
a second phase shifter having an input coupled to an input of the first set of one or more inputs and configured to receive a bias signal having an amplitude value that is constant over time; and
a second photonic combiner having a first input coupled to an output of the first phase shifter and a second input coupled to an output of the second phase shifter, an output of the second photonic combiner representing an output of the first set of one or more outputs.

3. The photonic circuit of claim 2, wherein a logical function of a cascading connection of the first photonic gate and the first nonlinear photonic circuit depends on a first phase shift applied by the first phase shifter, a second phase shift applied by the second phase shifter, and the amplitude value of the bias signal.

4. The photonic circuit of claim 1, wherein the photonic circuit is part of a photonic processor comprising the photonic circuit and a set of one or more other photonic circuits, one or more inputs of the set of one or other photonic circuits coupled to the one or more first outputs of the first nonlinear photonic circuit.

5. The photonic circuit of claim 1, further comprising:
a second photonic gate having a second set of one or more inputs and a second set of one or more outputs, the second set of one or more inputs coupled to the one or more first outputs and configured to receive the one or more first photonic output signals, the second photonic gate configured to generate, based at least in part on the one or more first photonic output signals, one or more second photonic intermediate output signals at the second set of one or more outputs; and
a second nonlinear photonic circuit having one or more second inputs and one or more second outputs, the one or more second inputs coupled to the second set of one or more outputs and configured to receive the one or more second photonic intermediate output signals, the second nonlinear photonic circuit configured to generate one or more second photonic output signals at the one or more second outputs by applying a second nonlinear transfer function of the second nonlinear photonic circuit to the one or more second photonic intermediate output signals.

6. The photonic circuit of claim 5, wherein a logical function of a cascading connection of the first photonic gate, the first nonlinear photonic circuit, the second photonic gate and the second nonlinear photonic circuit depends at least in part on phase shifts applied by a pair of phase shifters of the first photonic gate and on a phase shift applied by a phase shifter of the second photonic gate.

7. The photonic circuit of claim 5, wherein the second photonic gate comprises:
a phase shifter coupled to an output of the one or more first outputs of the first nonlinear photonic circuit; and
a photonic combiner having a first input coupled to an output of the phase shifter and a second input configured to receive a bias signal having an amplitude value that is constant over time, an output of the photonic combiner coupled to an input of the one or more second inputs of the second nonlinear photonic circuit.

8. The photonic circuit of claim 5, wherein the first nonlinear photonic circuit comprises a semiconductor optical amplifier (SOA) based amplitude thresholder and the second nonlinear photonic circuit comprises a saturable absorber.

9. The photonic circuit of claim 8, wherein the saturable absorber operates in a first operating regime defined by a first portion of a cumulative nonlinear transfer function of the first and second nonlinear photonic circuits or in a second operating regime defined by a second portion of the cumulative nonlinear transfer function, and the SOA-based amplitude thresholder operates in a third operating regime defined by a third portion of the cumulative nonlinear transfer function.

10. The photonic circuit of claim 9, wherein the SOA-based amplitude thresholder is configured to operate in the third operating regime based on one or more first amplitudes of the one or more first photonic intermediate output signals generated by the first photonic gate, and the saturable absorber is configured to operate in the first operating regime or the second operating regime based on one or more second amplitudes of the one or more second photonic intermediate output signals generated by the second photonic gate.

11. The photonic circuit of claim 9, wherein:
the saturable absorber is configured to apply a transfer gain of the second nonlinear transfer function to one or more second amplitudes of the one or more second photonic intermediate output signals, when the saturable absorber operates in the second operating regime;
the saturable absorber is configured to saturate the one or more second amplitudes of the one or more second photonic intermediate output signals to a first amplitude level, when the saturable absorber operates in the first operating regime; and
the SOA-based amplitude thresholder is configured to saturate one or more first amplitudes of the one or more first photonic intermediate output signals to a second amplitude level greater than the first amplitude level, when the SOA-based amplitude thresholder operates in the third operating regime.

12. The photonic circuit of claim 5, wherein the photonic circuit is part of a photonic processor comprising the photonic circuit and a set of one or more other photonic circuits, one or more inputs of the set of one or other photonic circuits coupled to the one or more second outputs of the second nonlinear photonic circuit.

13. The photonic circuit of claim 1, wherein the first nonlinear photonic circuit comprises one or more amplitude thresholders configured to apply the first nonlinear transfer function by saturating one or more amplitudes of the one or more first photonic intermediate output signals to one or more defined amplitude levels when generating the one or more first photonic output signals.

14. The photonic circuit of claim 1, wherein the first nonlinear photonic circuit comprises a cascading connection of one or more saturable absorbers and one or more semiconductor optical amplifier-based amplitude thresholders.

15. A non-transitory computer-readable storage medium comprising stored instructions that, when executed by at least one processor, cause the at least one processor to execute operations comprised to:
instruct a first photonic gate of a photonic circuit to receive one or more photonic input signals at a first set of one or more inputs;
instruct the first photonic gate to generate, based at least in part on the one or more photonic input signals, one or more first photonic intermediate output signals at a first set of one or more outputs;
instruct a first nonlinear photonic circuit of the photonic circuit to receive the one or more first photonic intermediate output signals at one or more first inputs; and
instruct the nonlinear photonic circuit to generate one or more first photonic output signals at one or more first outputs by applying a first nonlinear transfer function of the first nonlinear photonic circuit to the one or more first photonic intermediate output signals.

16. The computer-readable storage medium of claim 15, wherein the stored instructions comprise further stored instructions that, when executed, cause the at least one processor to:
instruct a first phase shifter of the first photonic gate to apply a first phase shift;
instruct a second phase shifter of the first photonic gate to apply a second phase shift different from the first phase shift; and
set an amplitude value of a bias signal input to the second phase shifter to a defined value, the amplitude value being constant over time,
wherein a logical function of a cascading connection of the first photonic gate and the first nonlinear photonic circuit depends on the first phase shift, the second phase shift, and the amplitude value of the bias signal.

17. The computer-readable storage medium of claim 15, wherein the stored instructions comprise further stored instructions that, when executed, cause the at least one processor to:
instruct a second photonic gate of the photonic circuit to receive the one or more first photonic output signals at a second set of one or more inputs coupled to the one or more first outputs;
instruct the second photonic gate to generate, based at least in part on the one or more first photonic output signals, one or more second photonic intermediate output signals at a second set of one or more outputs;
instruct a second nonlinear photonic circuit of the photonic circuit to receive the one or more second photonic intermediate output signals at one or more second inputs coupled to the second set of one or more outputs; and
instruct the second nonlinear photonic circuit to generate one or more second photonic output signals at one or more second outputs by applying a second nonlinear transfer function of the second nonlinear photonic circuit to the one or more second photonic intermediate output signals.

18. The computer-readable storage medium of claim 17, wherein the stored instructions comprise further stored instructions that, when executed, cause the at least one processor to:
instruct the second nonlinear photonic circuit to saturate the one or more second amplitudes of the one or more second photonic intermediate output signals to a first amplitude level, when the second nonlinear photonic circuit operates in a first operating regime;
instruct the second nonlinear photonic circuit to apply a transfer gain of the second nonlinear transfer function to one or more second amplitudes of the one or more second photonic intermediate output signals, when the second nonlinear photonic circuit operates in a second operating regime; and
instruct the first nonlinear photonic circuit to saturate one or more first amplitudes of the one or more first photonic intermediate output signals to a second amplitude level greater than the first amplitude level, when the first nonlinear photonic circuit operates in a third operating regime.

19. The computer-readable storage medium of claim 15, wherein the stored instructions comprise further stored instructions that, when executed, cause the at least one processor to:
instruct the first nonlinear photonic circuit to apply the first nonlinear transfer function by saturating one or more first amplitudes of the one or more first photonic intermediate output signals to one or more defined amplitude levels when generating the one or more first photonic output signals.

20. A method comprising:
receiving one or more photonic input signals at a first set of one or more inputs of a first photonic gate of a photonic circuit;
generating, by the first photonic gate at a first set of one or more outputs, one or more first photonic intermediate output signals based at least in part on the one or more photonic input signals;
receiving the one or more first photonic intermediate output signals at one or more first inputs of a first nonlinear photonic circuit of the photonic circuit; and
generating, by the first nonlinear photonic circuit at one or more first outputs, one or more first photonic output signals by applying a first nonlinear transfer function of the first nonlinear photonic circuit to the one or more first photonic intermediate output signals.
